(19) United States
(12) Patent Application Publication
(10) Pub. No.: US 2013/0203470 A1
(43) Pub. Date: Aug. 8, 2013

(54) Protective Display Surface

(71) Applicant: Ultra-Scan Corporation, Amherst, NY (US)

(72) Inventors: John K. Schneider, Snyder, NY (US); Jack C. Kitchens, Tonawanda, NY (US)

(73) Assignee: Ultra-Scan Corporation, Amherst, NY (US)

(21) Appl. No.: 13/758,688

(22) Filed: Feb. 4, 2013

Related U.S. Application Data
(60) Provisional application No. 61/594,333, filed on Feb. 2, 2012.

(51) Int. Cl. H04M 1/02

(52) U.S. Cl. CPC H04M 1/0202
USPC 455/566; 455/575.8

(57) ABSTRACT

A smart phone protective cover with an integrated waveguide array is disclosed. In a particular embodiment, the cover includes a portion adapted to contain a waveguide array designed to allow communications between the smart phone and a user. The invention may be implemented to facilitate cursor, display and/or navigation control relative to the smart phone.

### CROSS-REFERENCE TO RELATED APPLICATION

This application claims the benefit of priority to U.S. provisional patent application Ser. No. 61/594,333, filed on Feb. 2, 2012.

### FIELD OF THE INVENTION

The present invention relates to smart phones and similar devices having the ability to simultaneously display information and interact with a user through various touch functions.

### BACKGROUND OF THE INVENTION

Smart phones are the fastest growing segment of the wireless market. Smart phones combine the features of a personal digital assistant and a cell phone. The Apple iPhone® and other smartphones are popular devices, but they are also expensive. Accordingly, many types of cases have been developed to protect a smartphone from bumps, drops, scratches, and rough handling. For example, cases and surfaces may be made from or employ materials such as glass or plastic. A shortcoming of these cases is that the cases do not add functionality or communicate with the smart phone sensors to avoid missed calls or messages or allow the user to interact with the phone. Accordingly, what is needed in the art is a smart phone protective cover that has the ability to increase the functionality of the smartphone and to capture the user's attention.

An additional need exists in the art for an improved smart phone cover surface that is adaptable to provide protection for a smart phone display while allowing communication with the user. However, in view of the presently existing prior art, it is not obvious to those of ordinary skill in the art how the identified needs for ruggedness and communication with a sensor array can be fulfilled.

### SUMMARY OF THE INVENTION

The invention may be embodied as a device for providing touch-screen capability and simultaneously protect a smart phone from mechanical abuse, while also allowing interactive communication between the device and the user. A smart phone cover according to the invention may have a waveguide array positioned to he located between a communications area of a smart phone and a user when the user is communicating with the communications area. The communications area may be a sensor on the smart phone, and in that situation the waveguide array may be positioned to require communications between the user and the sensor to pass through the waveguide array. The communications area may be a display on the smart phone, and in that situation the waveguide array may be positioned to require light from the display to pass through the waveguide array.

The waveguide array may be one or more types of waveguides. For example, the waveguide array may be an ultrasonic waveguide array, or an optical waveguide array, or a micro-channel waveguide array, or a radio frequency waveguide array, or an infrared waveguide array. In this manner, when the sensor is an ultrasonic receiver array, the waveguide array may be an ultrasonic waveguide array. Also, when the sensor is an optical receiver array, and the waveguide array may be an optical waveguide array. In addition, when the optical sensor receiver array operates in the infrared region, the optical waveguide array may be one that conducts infrared light. Further, if the sensor is a capacitance array, then the waveguide array may be a micro-channel waveguide array. Finally, when the sensor is a radio frequency receiver array, the waveguide array may be a radio frequency waveguide array.

### BRIEF DESCRIPTION OF THE DRAWINGS

For a fuller understanding of the nature and objects of the invention, reference should be made to the accompanying drawing and the subsequent description. Briefly, the drawing is an exploded view of a surface of a smart phone and a cover according to the invention.

### FURTHER DESCRIPTION OF THE INVENTION

In an embodiment of the invention, a smart phone case or display cover (collectively the case and the cover are referred to as a “cover”) includes a waveguide array. The cover may include a transparent portion and an integrated waveguide array. The transparent portion may cover and protect a display screen of the smart phone. The integrated waveguide array may he positioned so that when the cover is used with the smart phone, the waveguide array covers a sensor array of the smart phone that is used to communicate and interact with the user. For example, the smart phone sensor array may be used to control operations of the smartphone.

The technology for constructing and using various waveguide array technologies is well known to those versed in the art. One such wave guide is described in detail in U.S. Pat. No. 8,119,709, “Acoustic Waveguide Array”. There are many types of waveguide arrays, such as those that are designed to conduct electromagnetic waves (e.g. light and radio waves), ultrasonic waves and electric charge (e.g. capacitance waveguides). Depending on the type of sensor used by the smart phone, a corresponding type of waveguide would be used in the cover.

Some smart phones include many sensors and/or displays, each with a different location. In that situation, the invention may be embodied as a cover having many waveguide arrays, each of which corresponds with a particular sensor and/or display of the smart phone so that the user is able to interact with the smart phone though the cover via the waveguide arrays. This may be particularly useful, for example, when keyboard keys and scroll buttons are not located on the smart phone is adjacent areas. In that situation, one waveguide array may be located to cover the keyboard keys, and another waveguide array may be located to cover the scroll buttons.

An advantage that a waveguide array imparts to a smart phone cover, besides the obvious ones of abrasion resistance and protection from electrostatic discharge (“ESD”), is that of improved sensor resolution. As such a waveguide array provides similar or superior protection as that afforded by a simple prior art plate from things like abrasion and ESD, but in addition a waveguide array allows for maintaining the smart phone sensor resolution because the waveguide array has superior dispersion and diffraction characteristics when compared to existing covers. As such, a waveguide array according to the invention will minimize energy losses and crosstalk between sensor elements, which can occur with existing prior art covers.

Having provided an overview of the invention, additional details will now be given.

In an embodiment of the invention, a smart phone protective cover 1 may be made from a sheet of plastic or glass, with a waveguide array 2 integrated into the glass or plastic sheet in order to create an assembly that will mate to and cover portions of a smart phone, such as a display 4 and a sensor array 3. Currently, the smart phone display 4 and smart phone sensor array 3 are fabricated on a substrate 5, such as glass or plastic.

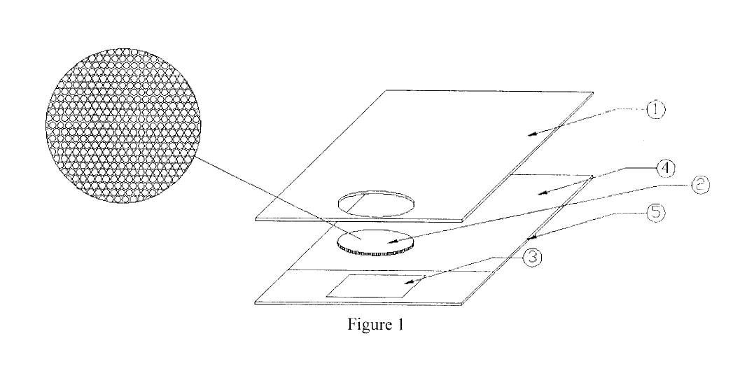

In the embodiment of the invention depicted in FIG. 1, the waveguide array 2 is positioned to correspond with the sensor array 3. It should be noted that alternate embodiments of the invention may position a waveguide array 2 to correspond with the display 4. Viewing the surface (sensor array 3 and/or display 4, as the case may be) via the waveguide array(s) 2, allows interaction between the sensor 3 (and/or display 4) and the user while also protecting the sensor array 3 (and/or the display 4).

There are different types of sensors used on smart phones. If the sensor array 3 is an optical sensor, the waveguide array 2 may be an optical fiber plate so that light can be conducted to/from the sensor. If the sensor array 3 is ultrasonic, the waveguide array may be an ultrasonic (also referred to in the industry as an “acoustic”) waveguide array. If the sensor 3 is capacitive, a micro channel array may be used. A micro channel array is a capillary array plate where the capillaries have their inner walls plated with a conductor such as silver so that electrons are easily conducted. Regardless of the type of sensor and corresponding waveguide array, the waveguide array 2 may best be oriented so that the individual waveguide elements are oriented substantially perpendicular to the surface of the protective cover 1. In this manner, the user can interactively communicate with the sensor array 3 and/or display 4 via the waveguide array.

The invention is not limited to one waveguide array 2 per cover. The invention may be implemented to have more than one waveguide array 2 integrated into the protective cover 1. Although it may be that each waveguide array 2 may be the same type (e.g. all optical, ultrasonic, capacitive, radio frequency, etc.), it is possible that different types of waveguide arrays 2 may be utilized in a particular cover. In this manner, a smart phone having different types of sensors 3 and/or displays 4 may receive the full benefit provided by a cover according to the invention. For example, if a smart phone has an optical display and an ultrasonic sensor, the protective cover may include an optical waveguide located to facilitate communications between the user and the display, and an ultrasonic waveguide located to facilitate communication between the user and the sensor.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A smart phone protective cover, comprising a waveguide array positioned to be located between a communications area of a smart phone and a user when the user is communicating with the communications area.

2. The smart phone cover of claim 1, wherein the communications area is a sensor on the smart phone, and the waveguide array is positioned to require communications between the user and the sensor to pass through the waveguide array.

3. The smart phone cover of claim 1, wherein the communications area is a display on the smart phone, and the waveguide array is positioned to require light from the display to pass through the waveguide array.

4. The smart phone cover of claim 1, wherein the waveguide array is an ultrasonic waveguide array.

5. The smart phone cover of claim 1, wherein the waveguide array is an optical waveguide array.

6. The smart phone cover of claim 1, wherein the waveguide array is a micro-channel waveguide array.

7. The smart phone cover of claim 1, wherein the waveguide array is a radio frequency waveguide array.

8. The smart phone cover of claim 1, wherein the waveguide array is an infrared waveguide array.

9. The smart phone cover of claim 1, wherein the sensor is an ultrasonic receiver array, and the waveguide array is an ultrasonic waveguide array.

10. The smart phone cover of claim 1, wherein the sensor is an optical receiver array, and the waveguide array is an optical waveguide array.

11. The smart phone cover of claim 10, wherein the optical sensor receiver array operates in the infrared region, and the optical waveguide array conducts infrared light.

12. The smart phone cover of claim 1, wherein the sensor is a capacitance array, and the waveguide array is a micro-channel waveguide array.

13. The smart phone cover of claim 1, wherein the sensor is a radio frequency receiver array, and the waveguide array is a radio frequency waveguide array.
